(19) United States
(12) Patent Application Publication
(10) Pub. No.: US 2018/0293467 A1
(43) Pub. Date: Oct. 11, 2018

(54) METHOD FOR IDENTIFYING CORRESPONDING IMAGE REGIONS IN A SEQUENCE OF IMAGES

(71) Applicant: Testo SE & Co. KGaA, Lenzkrich (DE)

(72) Inventors: Robert Wulff, Freiburg (DE); Dominik Wolters, Flintbek (DE)

(73) Assignee: Testo SE & Co. KGaA, Lenzkirch (DE)

(21) Appl. No.: 15/946,150

(22) Filed: Apr. 5, 2018

(30) Foreign Application Priority Data
Apr. 5, 2017 (DE) 102017107335.3

(51) Int. Cl. G06K 9/68; G06K 9/62; G06T 7/13

(52) U.S. Cl. CPC G06K 9/68; G06K 9/6211; G06T 17/00; G06T 2207/10016; G06T 7/13

(57) ABSTRACT

A method for identifying corresponding image regions in a sequence of images (1; 21) is provided, wherein one or more features (P2a, P2b) from a second image are assigned to each feature (P1a, P2a) from a first image using correspondence graphs. The costs (C1-C5) that are associated with each assignment are represented by functions. The concrete selection of a unique correspondence for each feature which is then used for the further calculations is performed on the basis of these costs.

### INCORPORATION BY REFERENCE

The following documents are incorporated herein by reference as if fully set forth: German Patent Application No. 10 2017 107 335.3, filed Apr. 5, 2017.

### BACKGROUND

The invention describes a method for identifying corresponding image regions in a sequence of images, wherein, in the images, in each case a multiplicity of features are detected in computer-assisted fashion and in each case descriptors relating to the features are extracted in computer-assisted fashion, wherein a first feature of a first image and a second feature of a second image of the sequence are recognized as being in correspondence with one another in terms of content if at least the associated descriptors are similar to one another in accordance with a defined rule, so that a first image region of the first image with the first feature is recognized as being in correspondence in terms of content with a second image region of the second image with the second feature.

By way of the identification of the corresponding image regions in a sequence of images, it is possible for example to recognize a movement of the image region if the images were recorded from a stationary position.

However, it is also possible to use the different positions of the image regions in the individual images if they were recorded from different camera poses to create a three-dimensional model.

DE 10 2016 002 186 A1 discloses, for example, to calculate a three-dimensional model of an object from a sequence of images of the object that were recorded from different locations and/or perspectives.

How easy individual features in an image are to identify is here highly dependent on the geometry and the surface of the recorded object. Typically, descriptors are to this end calculated relating to the individual features, with which descriptors the feature can be more easily described and identified. It can still be difficult to identify the individual features within the individual images and to assign them to one another. One particular difficulty is here due to features that are not present in an image because they are obscured, for example, or are not visible due to the perspective. False assignments can here easily occur if a different feature has a descriptor that is sufficiently similar.

This can occur in particular in the case of objects that have many similar features. A building facade having a plurality of identical windows, for example, is such an object. Depending on a change in recording poses between two images, it is possible here, for example, for a window in one image to be identified in a subsequent image with a neighbouring window.

In such a case, the image regions do not sufficiently differ, and the extractable descriptors therefore have insufficient distinctive character. Creating a three-dimensional model is then not possible without errors.

### SUMMARY

It is therefore the object of the invention to provide a method and an apparatus that permit improved identification of the features in an image sequence, such that for example a three-dimensional model is better and more easily able to be calculated in computer-assisted fashion.

This object is achieved by way of a method as well as a site measuring device having one or more features of the invention.

The method according to the invention is characterized in particular in that, for the recognition of a content correspondence, it is additionally checked whether at least one first further feature M1B, which neighbours the first feature M1A in the first image, is similar in accordance with a specified rule to a second further feature M2B, which neighbours the second feature M2A in the second image.

What is crucial here is that a feature A is placed into a neighbouring relationship with at least one further feature B. Neighbouring in this case can mean, for example, that the distance between the features in the image is below a specifiable or settable limit. It is also possible for both features to have a geometric and/or topographic relationship.

In this way, in each case a first feature M1A and a first further feature M1B can be combined into one feature group. In a further image, it is now possible, proceeding from the second feature M2A, which is intended to correspond to the first feature M1A, to additionally investigate whether a second further feature M2B, which corresponds to the first further feature M1B and is situated in a similar neighbourhood with respect to the second feature, is also present in the second image. That means, a similar feature group is present in the further image.

As opposed to the prior art, the identification can thus be significantly improved, because in addition to the descriptors, at least one additional distinguishing criterion is present.

In this way, it is also possible in the case of many similar image regions to reliably identify a feature, because the neighbourhoods permit a further differentiation.

Moreover, the identification of the features can be improved in nearly arbitrary fashion by increasing the number of the neighbouring features that are being considered.

In particular, the method according to the invention provides for a content correspondence between the first feature M1A and the second feature M2A to be confirmed if the examination showed that the first further feature M1B and the second further feature M2B are similar to one another, and/or to be discarded if the examination showed that no first further feature M1B and no second further feature M2B exist that are similar to one another.

In an advantageous configuration of the invention, the first feature M1A and the second feature M2A were detected using a corner and/or edge detection and/or are not robust features.

Robust features are features that are very easily and reliably detectable in an image by way of an algorithm. These robust features are also reliably identifiable within an image sequence. Generally, however, these robust features are located in image regions that have no features that are relevant to a user. The method according to the invention therefore improves in particular the identifiability of such features of interest, which, however, are not robust features.

Expediently, the first further feature M2A and the second further feature M2B are optimized for a content-related assignment of image regions in a sequence of images. The first further feature M2A is highly reliably uniquely identifiable in a subsequent image with the second further feature due to its property. It is therefore simple to check whether said second further feature M2B is also situated in the neighbourhood of a feature M2A, which is similar to the first feature M1A, in the subsequent image. If this similarity exists, it is possible to assume with a high degree of reliability that the second feature M2A is identical to the first feature M1A. The identification is here performed substantially via the optimized further features that can be found and their neighbourhood with other features.

It is particularly advantageous here if the first further feature and the second further feature are robust features. Robust features can be determined, for example, in accordance with one of the following methods: SIFT (scale-invariant feature transform), SURF (speeded up robust features) or the like.

For each feature, a separate further feature is preferably determined. However, it is also possible for two features to use the same further feature if, for example, no additional further features are available. In this case, the neighbourhood relationship between the features then differs such that in this case, unique assignment between the features is also possible.

In an advantageous embodiment of the invention, a first further feature M1B is considered to be neighbouring a first feature M1A if it is situated in the first image within a specified circle around the first feature. During the search, it is also possible for the radius of the circle to be incrementally increased until a suitable further feature has been found.

Additionally or alternatively, a graph can be determined that models a relationship between the first feature M1A and the first further feature M1B. Such a graph can be in particular a topological graph. A topological graph here determines, for example, the location of a point with respect to a line in an image. In simplified terms, a point can consequently be defined, for example, as a starting point of a line or as a point of intersection between two lines. These properties, however, are also dependent on the recording pose. Consequently, a point can be seen in an image at the start of a line, even though it is not connected to the line at all. In a further image, said point is then remote from the line.

In an expedient development, point features are primarily defined as points of intersection of lines, in particular straight lines. The neighbouring relationships here exist in each case in alternation between point and line, and can likewise be described by graphs. In particular, it is possible in this way to also form complex and/or closed shapes by arranging points and lines in series.

It is also possible here to set up and consider reciprocal relationships for each first feature M1A and each second feature M2A and each first further feature M1B and each second further feature M2B. In this way, a cross assignment is obtained, which can also be effected over a plurality of features. Said cross assignment permits a particularly exact assignment, because neighbourhoods are evaluated in a plurality of dimensions.

In particular, in each case one correspondence graph with relevant features of the second image is created for features of the first image. Each of these correspondence graphs then contains a cost function as a measure of the similarities of the features. Due to the cost functions, a selection of the corresponding feature can then be performed. For example, if two features in the second image are located within the circle around a feature, then the cost function can include the distance in pixels, with the result that it can be compared to the distance in the first image. A decision as to which of the two features is the one that is associated with the first feature can then be determined on the basis of said cost function.

The identified features can be used for various purposes. A particularly advantageous embodiment of the invention is provided by a method for calculating 3D coordinates with respect to a first feature in a first image of a sequence of images and a second feature of a second image of the sequence, wherein a method according to the invention for identifying corresponding image regions as described above is performed and, based on the preferably confirmed content correspondences, a 3D coordinate with respect to the first feature and second feature is calculated in computer-assisted fashion, in particular in a 3D model that is generated at least from the first further feature and the second further feature. The features therefore serve as the basis for the creation of a three-dimensional model of an object in the image of which the features are constituent parts. This calculation of the model can be performed in accordance with any desired known method, such as a structure-from-motion method. However, the advantage of the invention is the significantly improved identification of the features due to the neighbouring relationships. The model that can thus be created can therefore be calculated in a substantially better and more accurate manner.

The invention furthermore comprises a site measuring device, which is suitable in particular for performing a method according to the invention.

An advantageous embodiment comprises a site measuring device having a camera for recording a sequence of images and a computer processor, which is set up for performing a method in accordance with the preceding claim, wherein the computer processor is set up for a computer-assisted calculation of a geometric parameter of an object under investigation, which is imaged in the images of the sequence, on the basis of 3D coordinates calculated using the method, in particular wherein output means are configured for outputting a calculated value of the geometric parameter.

### BRIEF DESCRIPTION OF THE DRAWINGS

The invention is described in more detail with reference to a few advantageous exemplary embodiments and with respect to the following drawings.

In the figures:

FIG. 1 shows a first image having a line structure and a plurality of features,

FIG. 2 shows a second image of the line structure from a different recording pose,

FIG. 3 shows a schematic illustration of the illustration of the neighbourhood relationships using graphs,

FIG. 4 shows a schematic illustration of a site measuring device according to the invention.

### DETAILED DESCRIPTION FO THE PREFERRED EMBODIMENTS

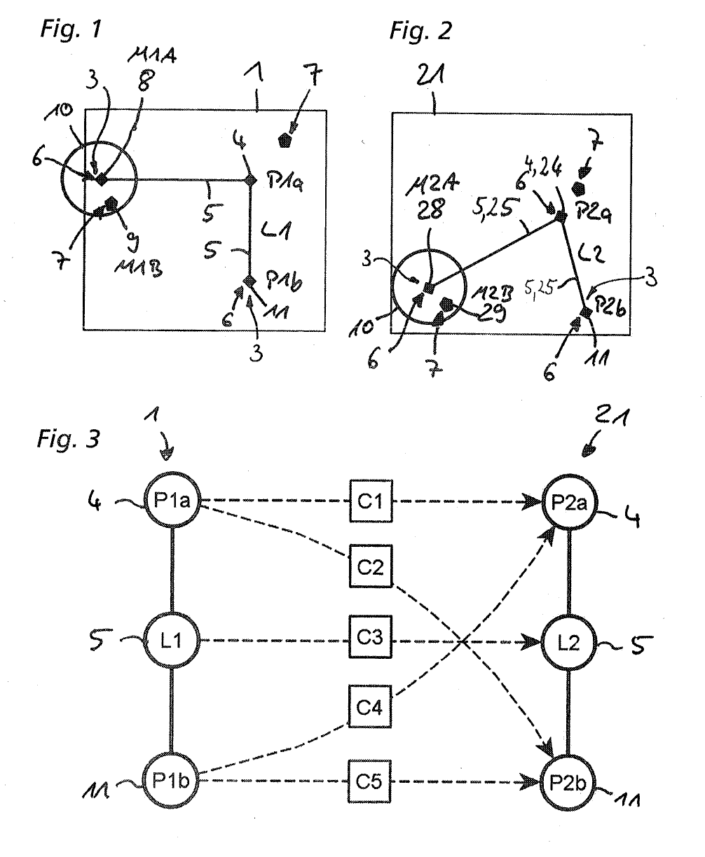

FIG. 1 shows, by way of example, a first image 1, in which a substantially L-shaped structure 2 is present. The structure 2 has two endpoints 3 and a kink point 4, which are connected by two mutually perpendicular lines 5.

The points 3, 4 and lines 5 of the structure 2 have been recognized as features 6, for example in an edge detection method.

Furthermore present in the image 1 are two robust features 7 within the meaning of the invention. These robust features 7 have been recognized, for example, using SIFT or SURF methods.

FIG. 2 shows a second image 21, which shows the same structure 2, but which was recorded from a different camera pose. Due to the recording perspective, the L-shaped structure 2 now appears in an acute angle and rotated with respect to the first image 1. In the second image 21, the lines 25 and points 24 can likewise be found in computer-assisted fashion using a known method, but the identification with the lines 5 and points 4 of the first image 1 can be difficult due to the perspective distortion.

In accordance with the invention, neighbouring relationships between the features are therefore determined and considered.

To illustrate the method, first, only one feature M1A 8 is considered for the sake of simplicity, here, the left-hand starting point 3 of the horizontal line 2.

In the first image 1, the starting point is recognized as a first feature M1A 8. In the second image 21, the starting point was recognized as a second feature M2A 28. The features are not easily identifiable between the images due to the different perspectives.

However, in the first image 1, the first feature M1A 8 is situated so as to directly neighbour a first further feature M1B 9, which in the example is a robust feature 7. Neighbouring here means, for example, that the two features are situated approximately within a circle 10 having a predetermined radius.

The robust feature 7 has the property that it is very easily identifiable in images, in particular independently of the perspective or recording pose. In the second image 21, the second further feature M2B 29 can therefore be very easily recognized and identified with the first further feature M1B 9 of the first image 1.

Since it is now known that in the first image 1, a first feature M1A 8 is located in the neighbourhood of the first further feature M1B 9, it is now possible in the second image 21 to likewise search the neighbourhood of the second further feature M2B 29 for a second feature M2A 28. It is here possible to use for example the same circle 10 as search area in the second image 21 as was used in the first image 1. In the example, a second feature M2A 28 is now found within the circle 10. It is now possible to deduce, via the relationship between the first further feature M1B 9 and the first feature M1A 8, that the second feature M2A 28, which neighbours the second further feature M2B 29 in the second image 21, must be identical to the first feature M1A 8. Unique identification is therefore possible, even if the second feature alone would not be identifiable with the first feature.

The kink point 4, which is likewise located in the neighbourhood of a robust feature 7, can for example also be dealt with analogously to the identification of the starting point of the line 5.

In principle, it would also be possible to enlarge the circle 10 for searching for a robust feature, if no robust feature 7 is situated in the original circle 10. In the example, the endpoint 11 of the line 5 could therefore also be correlated with one of the two robust features 7. Since the distance from the feature is also taken into account here, the search for the feature in the second image will also be effected at this distance or a similar distance from the robust feature. However, what may also happen here is that a false feature is also situated in the specified, large search radius, in particular if many features are present. Overall, it is therefore advantageous if the circle of the search radius is kept as small as possible, with the result that only one further feature or a few further features are situated in this circle.

In the search for neighbouring features, it is also possible, in addition to the circle, to consider a transform between the two images. It is possible to determine from the robust features 7 a movement, i.e. a translation and rotation, between the images. The circle for searching for a neighbouring feature can therefore be transferred initially to the second image with this transform, such that the search can be started earlier in the correct image region.

To improve the search results, it is also possible to correlate a first feature with two further features. In the example, the first feature, such as the kink point of the line, could then be linked to the two robust features. It is then possible to also define cross-relationships between all three features. As a result, the accuracy and hit probability during the identification of the features can be increased or improved. That means that, if in a second image features are then found in which all these relationships are similar, the probability that they have been identified correctly is significantly greater than in the case of only one neighbouring relationship. A plurality of such relationships also help compensate for geometric or perspective distortions.

An additional advantage is noted if, in a second image, one of the robust features is not visible because it is obscured, for example. In this case, although one of the neighbouring relationships for the second image is missing, it is still possible due to the second relationship to identify a feature if it can be classified as being similar enough.

It is even possible with this method to identify a missing feature that is not a robust feature. For example, were the kink point missing in the second image, it would be possible to insert it in the image by way of interpolation from the neighbourhood relationships with respect to the two robust features. However, this works only if the missing feature lies within the image.

The endpoint 11 of the structure 2 now is not in a direct neighbourhood with a robust feature 7. Nevertheless, it is possible to define even for this feature 12 a neighbouring relationship. Consequently, the feature 12 can be defined for example as an endpoint of the adjoining line 5, the starting point of which is the kink point 4. It is possible in this way to correlate even a plurality of features that are not robust features with one another. It is possible in particular in this way to link points, which were defined for example as an intersection between two lines, to the lines. In this way, neighbouring relationships are obtained in continuous alternation between point and line.

The kink point 4, in turn, is very easily uniquely identifiable due to the neighbourhood with respect to a robust feature 7. The line 5 as such is likewise easily recognizable in the second image. Consequently, all that is necessary for the positive identification of the endpoint 11 in the second image 21 is a confirmation that the endpoint is likewise located on the line 5 through the kink point 4.

Such a reference to an adjoining line or to another feature that is not a robust feature can, even with the presence of a further feature, i.e. a robust feature in the neighbourhood of a feature to be examined, be used in addition to it.

The identification of the features between the images, including using the neighbourhoods, is effected for example by way of graphs. It is possible here to distinguish between topological graphs and correspondence graphs. A topological graph can describe for example the reference to an adjoining feature, such as a line or the like.

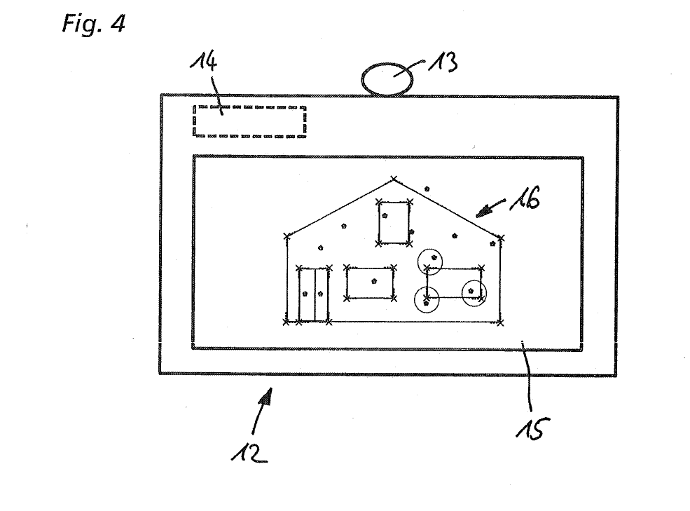

FIG. 3 indicates by way of example the method for finding correspondence between two images using graphs. For the sake of simplicity, in each image a line feature having two adjoining point features has been detected. In FIG. 1, these could correspond to the perpendicular line 5 between the kink point 4 and the endpoint 11. In a first image (on the left in FIG. 3), these are the point features P1a and P1b, which are connected topologically to the line feature L1. Each of the three features is symbolized by a circle, and the neighbourhood relationship by way of dashed lines. In image 2 (on the right in FIG. 3), these are analogously the features P2a, P2b and L2.

Each feature of the first image is now connected to its corresponding feature in the second image by way of a correspondence graph (solid arrows). The correspondence graph here contains what is known as a cost function, which expresses the similarity. A lower value of the cost function, i.e. low costs, here indicates a high similarity and therefore a great probability that the features between the images are assigned to one another. The cost function can contain, for example, the photometric and/or geometric similarity and/or further factors.

In the method according to the invention for finding correspondence, the neighbouring relationship of the features is additionally evaluated. As an example, the correspondence with the line L1 is to be found in the second image. In the first image, the line L1 has two neighbouring relationships with the points P1A and P1B. In the second image, the line L2 also has two neighbouring relationships with the points P2A and P2B. For this reason, in addition to the direct cost function C3, the cost functions between the neighbouring points are considered. The cost function for the line is therefore calculated as C3+Min(C1,C2)+Min(C4,C5). The correspondences are then determined by the minimum values of the cost functions.

This summation using cost functions can also be performed over three or more images. In particular, in the case of three images, the re-projection errors of the features can be included in the cost function as an addend, as a result of which the finding of correspondences is significantly increased.

In addition, it is also possible to test not only direct neighbours, but also to include the neighbouring relationships over N degrees in the cost function. In particular, it is possible to take into consideration all neighbours in a continuous chain on graphs.

It is here certainly possible for the cost function to permit an incomplete assignment. However, the method according to the invention has the advantage that, for example, if additional images are recorded or if a cost function has proven to be unfavourable, easier corrections may be performed.

FIG. 4 shows a site measuring device 12, which is configured and suitable for performing the method according to the invention.

The site measuring device 12 has an image recording unit 13 for recording a sequence of images of an object. The site measuring device 12 furthermore has a computer processor 14, which is set up for performing a method according to the invention, wherein the computer processor 14 is set up for a computer-assisted calculation of a geometric parameter of an object under investigation, which is imaged in the images of the sequence, on the basis of 3D coordinates calculated using the method.

In addition, the site measuring device 12 has a screen 15 as an output, on which a created model 16 and/or a calculated value of a geometric parameter may be displayed.

The invention describes a method for identifying corresponding image regions in a sequence of images 1; 21, wherein one or more features P2a, P2b from a second image are assigned to each feature P1a, P2a from a first image using correspondence graphs. The costs C1-C5 that are associated with each assignment are represented by functions. The concrete selection of a unique correspondence for each feature which is then used for the further calculations is performed on the basis of said costs.

### LIST OF REFERENCE SIGNS

1 first image

2 structure

3 starting point/endpoint

4 kink point

5 line

6 feature

7 robust feature

8 first feature

9 first further feature

10 circle

11 endpoint

12 site measuring device

13 image recording unit

14 computer processor

15 screen

16 model

21 second image

24 point

25 line

28 second feature

29 second further feature

P1a point feature

P1b point feature

P2a point feature

P2b point feature

L1 line feature

L2 line feature

C1 . . . C5 cost function

1. A method for identifying corresponding image regions in a sequence of images (1; 21), comprising: in the images (1; 21), for each said image detecting a multiplicity of features (6, 7) by computer image processing using a computer and for each said image, extracting descriptors relating to the features (6, 7) using the computer image processing, recognizing a first features M1A (8) of the features from a first one of the images (1) of the sequence of images and a second features M2A (28) of the features from a second one of the images (21) of the sequence of images as being in correspondence with one another in terms of content if at least the descriptors associated with first and second ones of the features are similar to one another in accordance with a defined rule, so that a first image region of the first image (1) with the first feature M1A (8) is recognized as being in correspondence in terms of content with a second image region of the second image (21) with the second feature M1B (28), and for recognition of a content correspondence, additionally checking whether at least one first further feature M2A (9), which neighbours the first feature M1A (8) in the first image (1), is similar in accordance with a specified rule to a second further feature M2B (29), which neighbours the second feature M1B (28) in the second image (21).

2. The method according to claim 1, further comprising confirming a content correspondence between the first feature M1A (8) and the second feature M2A (28) if an examination shows that the first further feature M1B (9) and the second further feature M2B (29) are similar to one another, or discarding a content correspondence if the examination shows that no first further feature M1B (9) and no second further feature M2B (29) exist that are similar to one another.

3. The method according to claim 1, wherein the detecting of the first feature M1A (8) and the second feature M2A (9) comprises at least one of a corner or an edge detection.

4. The method according to claim 1, further comprising optimizing the first further feature M1B (9) and the second further feature M2B (29) for a content assignment of image regions in at least one of a sequence of images or robust features (7).

5. The method according to claim 1, further comprising considering said first further feature to be neighbouring said first feature if it is situated in the first image within a specified circle around the first feature or if a graph is determinable that models a relationship between the first feature and the first further feature, or both.

6. The method according to claim 1, further comprising determining the similarities between the features of the first image (1) and the features of the second image (21) using correspondence graphs.

7. A method for calculating 3D coordinates with respect to a first feature M1A (8) in a first image (1) of a sequence of images and a second feature M2A (28) of a second image (21) of the sequence of images, performing the method for identifying corresponding image regions according to claim 1, and based on a confirmed content correspondence, calculating a 3D coordinate with respect to the first feature M1A (8) and the second feature M2A (28) using a 3D computer model that is generated at least from the first further feature M1B (9) and the second further feature M2B (29).

8. A site measuring device (12) comprising: a camera (13) for recording a sequence of images, a computer processer (14) for processing data configured for performing the method of claim 7, the computer processor (14) further configured for a computer-assisted calculation of a geometric parameter of an object under investigation, that is imaged in the sequence of images, on the basis of the 3D coordinates that are calculated, and an output device (15) that outputts a calculated value of the geometric parameter.
